(19) United States
(12) Patent Application Publication
(10) Pub. No.: US 2015/0063217 A1
(43) Pub. Date: Mar. 5, 2015

(54) MAPPING BETWEEN VARIABLE WIDTH SAMPLES AND A FRAME

(71) Applicant: LSI Corporation, San Jose, CA (US)

(72) Inventors: Avinash Kant Raikwar, Bangalore (IN); Amit Kumar Mishra, Bhubanwaswar (IN); Jayendra Dwaraka Bhamidipatti, Bangalore (IN)

(73) Assignee: LSI Corporation, San Jose, CA (US)

(21) Appl. No.: 14/016,522

(22) Filed: Sep. 3, 2013

Related U.S. Application Data
(60) Provisional application No. 61/870,888, filed on Aug. 28, 2013.

(51) Int. Cl. H04W 72/04

(52) U.S. Cl. CPC H04W 72/048
USPC 370/329

(57) ABSTRACT

An apparatus having a plurality of first circuits, a second circuit and a plurality of processor circuits is disclosed. Each first circuit is configured to store a plurality of samples corresponding to a plurality of channels. At least two of the samples having different widths. The second circuit is configured to store a plurality of frames each sized to contain two or more of the samples. The processor circuits are configured to (i) read the samples from the first circuits respectively, (ii) generate a transmit one of the frames by writing the samples to the second circuit based on one or more access pointers and (iii) pass control of the access pointers among the processor circuits.

This application relates to U.S. Provisional Application No. 61/870,888, filed Aug. 28, 2013, which is hereby incorporated by reference in its entirety.

### FIELD OF THE INVENTION

The invention relates to distributed radio base stations generally and, more particularly, to a method and/or apparatus for mapping between variable width samples and a frame.

### BACKGROUND

A concept of distributed base stations and remote radio heads is an emerging trend and is being used significantly in heterogeneous wireless networks. Conventional radio interfaces use industry-standard interface protocols to connect digital baseband units and analog radio modules in modern base transceiver stations. The radio interface protocols perform time division multiplexing of IQ data for different channels with variable sample widths to form master frames. The master frames are serialized and transmitted to receivers. The receivers demultiplex the data for the different channels from the master frames. However, interfaces inside modules used in the transmitters and the receivers are proprietary and cannot be expanded to accommodate new protocols.

### SUMMARY

The invention concerns an apparatus having a plurality of first circuits, a second circuit and a plurality of processor circuits. Each first circuit is configured to store a plurality of samples corresponding to a plurality of channels. At least two of the samples having different widths. The second circuit is configured to store a plurality of frames each sized to contain two or more of the samples. The processor circuits are configured to (i) read the samples from the first circuits respectively, (ii) generate a transmit one of the frames by writing the samples to the second circuit based on one or more access pointers and (iii) pass control of the access pointers among the processor circuits.

### BRIEF DESCRIPTION OF THE FIGURES

Embodiments of the invention will be apparent from the following detailed description and the appended claims and drawings in which:

FIG. 1 is a block diagram of a system;

FIG. 2 is a block diagram of a mapping circuit of the system in a transmit mode in accordance with an embodiment of the invention;

FIG. 3 is a flow diagram of a method for gathering and processing transmit samples;

FIG. 4 is a flow diagram of a method for mapping the transmit samples into a frame;

FIG. 5 is a block diagram of the mapping circuit in a receive mode;

FIG. 6 is a flow a flow diagram of a method for parsing receive samples; and

FIG. 7 is a flow diagram of a method for processing and demapping the receive samples.

### DETAILED DESCRIPTION OF THE EMBODIMENTS

Embodiments of the invention include providing mapping between variable width samples and a frame that may (i) accommodate multiple protocols, (ii) accommodate multiple mapping schemes, (iii) be expandable to different numbers of channels, (iv) exchange pointers to manage the mapping, (v) provide a scalable structure (vi) be free from granularity limitations on the width of the samples and/or (vii) be implemented as one or more integrated circuits.

An architecture of the invention is explained for some cases in terms of a Common Public Radio Interface (e.g., CPRI) protocol. The resulting hardware scheme is generic and can be used for an Open Base Station Architecture Initiative—Reference Point 3 (e.g., OBSA1-RP3) or any other similar protocols that maps data from different data streams to a particular slot in a frame.

A basic frame of the Common Public Radio Interface protocol includes a control word and multiple (e.g., 15) data words A control word is 1 byte, 2 bytes, 4 bytes, 8 bytes, 10 bytes or 16 bytes wide, depending on a line rate. A data word is generally 1×15 bytes, 2×15 bytes, 4×15 bytes, 8×15 bytes, 10×15 bytes or 16×15 bytes, depending on the line rate. A common mapping criterion in all Common Public Radio Interface protocol mapping methods is that “S” number of samples from an antenna carrier channel are mapped to the data words in “K” number of basic frames. The widths of the samples are different for different antenna carrier streams and depend on an application layer. A frame thus formed is serialized and transmitted to another node that receives the samples.

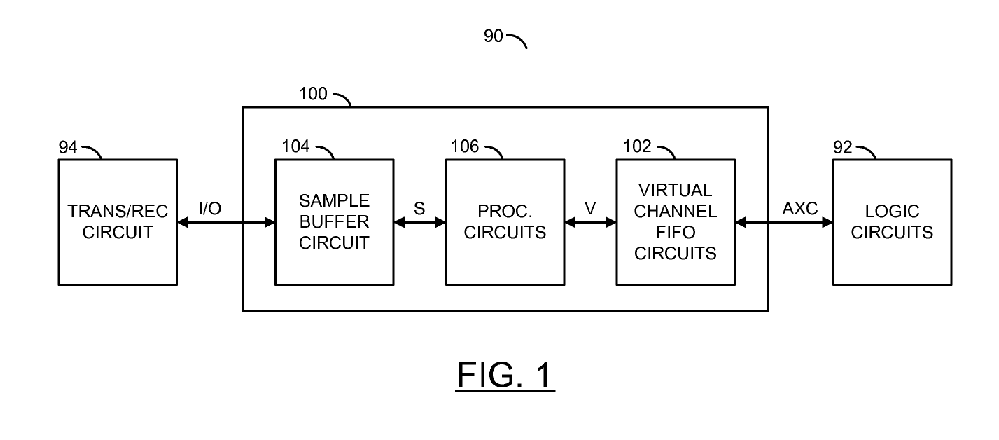

Referring to FIG. 1, a block diagram of an example implementation of a system 90 is shown. In some embodiments, the system 90 forms part of a base station. The system (or architecture) 90 generally comprises a block (or circuit) 92, a block (or circuit) 94 and a block (or circuit) 100. The circuit 100 generally comprises a block (or circuit) 102, a block (or circuit) 104 and a block (or circuit) 106. The circuits 92 to 106 may represent modules and/or blocks that may be implemented as hardware, software, a combination of hardware and software, or other implementations.

A bidirectional input/output signal (e.g., I/O) is shown exchanged between the circuit 94 and the circuit 100/104. The signal I/O carries input data (e.g., receive frames) received by the circuit 94 and output data (e.g., transmit frames) to be transmitted by the circuit 94. The circuit 100/102 exchanges a bidirectional antenna channel signal (e.g., AXC) with the circuit 92. The signal AXC carries output data (e.g., received samples) to the circuit 92 and input data (e.g., transmit samples) to the circuit 100. A signal (e.g., S) is shown exchanged between the circuit 104 and the circuit 106. The signal S conveys sample data between the circuits 104 and 106 and pointers generated by the circuit 106. A signal (e.g., V) is shown exchanged between the circuit 102 and the circuit 106. The signal V conveys sample data between the circuits 102 and 106 and pointers generated by the circuit 106.

The system 90 is applicable for mapping in-phase and quadrature-phase (e.g., IQ) data (or samples) in radio interface protocols used in modern base stations. The system 90 is applicable to any open radio interface protocols that multiplexes the data samples (e.g., Common Public Radio Interface and OBSA1-RP3 radio interface standards). The system 90 uses a processing element and a virtual channel per antenna carrier data stream to perform the mapping. Transmit samples are stored in the circuit 104 for subsequent transmission in a transmit path (e.g., a radio downlink). Receive samples from a receive path (e.g., a radio uplink) are also stored in the circuit 104 before subsequent demapping.

The circuit 92 is shown implementing one or more logic circuits. The circuit 92 is operational to create the samples being transmitted (or sent) by the circuit 94. The samples are typically grouped in multiple virtual channels per antenna carrier stream. The circuit 92 is also operational to process the samples received by the circuit 94. In some embodiments, the circuit 92 includes one or more baseband processors. The circuit 92 controls reading of receive samples from the circuit 102 via the signal AXC. The circuit 92 also controls writing of transmit samples into the circuit 102 via the signal AXC.

The circuit 94 is shown implementing an transmitter/receiver circuit. In a transmission mode, the circuit 94 is operational to transmit multiple master frames using radio frequency signals. The transmit master frames are received from the circuit 104 via the signal I/O. In a receive mode, the circuit 94 is operational to receive multiple master frames via the radio frequency signals. The received master frames are transferred to the circuit 104 via the signal I/O. The circuit 94 includes a serialization-deserialization conversion operations that translate serial data transmitted and received over a network to parallel data read from and written into the circuit 104.

The circuit 100 is shown implementing a mapping circuit. The circuit 100 is operational in a transmit mode to (i) read transmit samples received from the circuit 92, (ii) generate a transmit frame by writing the samples to a buffer based on one or more access pointers, (iii) transfer the frame to the circuit 94 and (iv) pass control of the access pointers among multiple internal processor elements. In a receive mode, the circuit 100 is operational to (i) read a receive frame transferred from the circuit 94 based on the access pointers, (ii) write the samples within the frame to respective buffer circuits, (iii) transfer the receive samples to the circuit 92 and (iv) pass control of the access pointers among the internal processor elements.

The circuit 102 is shown implementing a virtual channel first-in-first-out (e.g., FIFO) buffer circuit. In the transmit mode, the circuit 102 is operational to buffer one or more transmit samples received from the circuit 92 per each virtual channel. The buffering is provided in a first-in-first-out order. The transmit samples are subsequently copied to the circuit 106, one or more samples at a time per each virtual channel. The number of transmit samples is determined by configuration values. In the receive mode, the circuit 102 is operational to receive one or more current receive samples generated by the circuit 106 per each virtual channel. The number of receive samples is determined by the configuration values. The current receive samples are subsequently buffered until ready to be transferred to the circuit 92. The buffering is provided in the first-in-first-out order.

The circuit 104 is shown implementing an IQ sample buffer circuit. In the transmit mode, the circuit 104 is operational to buffer a current transmit frame being multiplexed and one or more transmit frames already assembled and ready to transmit. The transmit frames are buffered in the first-in-first-out order. In the receive mode, the circuit 104 is also operational to buffer one or more receive frames and buffer a current receive frame being demultiplexed. The receive frames are buffered in the first-in-first-out order.

The circuit 106 is shown implementing a multiple processor circuit. In the transmit mode, the circuit 106 is operational to process samples being transferred from the circuit 102 to the circuit 104. In the receive mode, the circuit 106 is operational to process samples being transferred from the circuit 104 to the circuit 102.

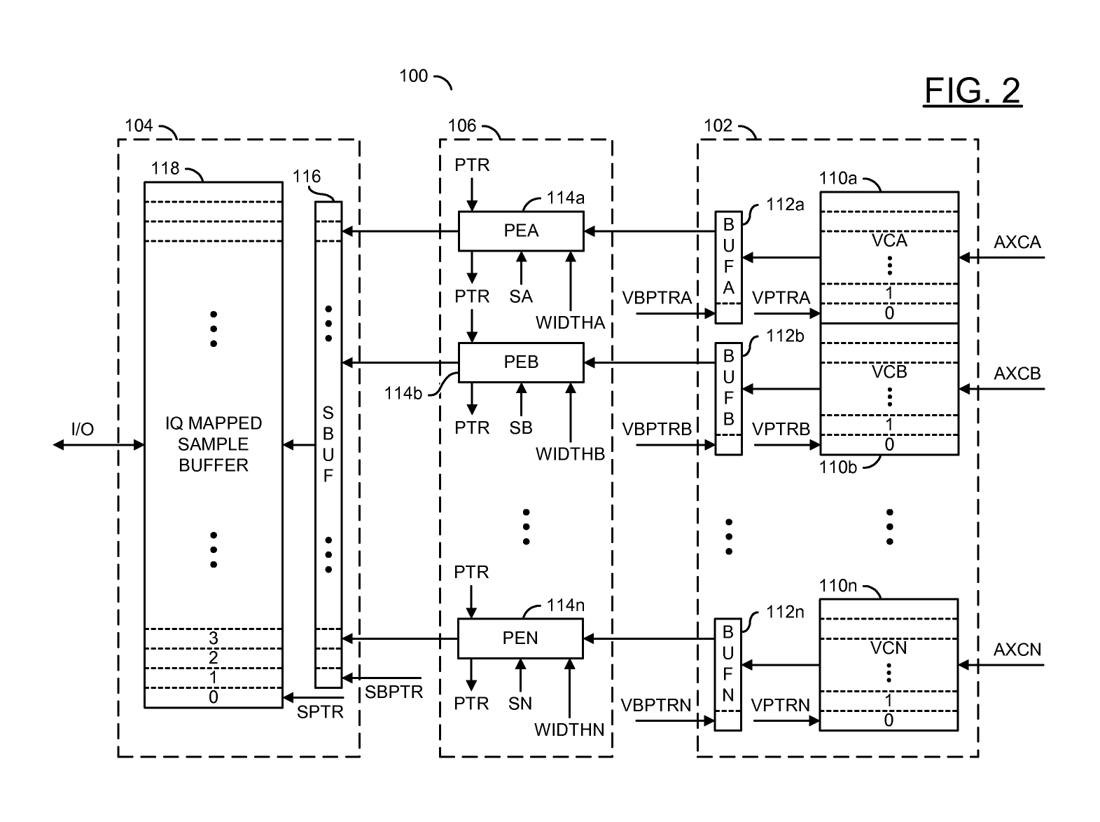

Referring to FIG. 2, a block diagram of an example implementation of the mapping circuit 100 in a transmit mode is shown in accordance with an embodiment of the invention. The circuit 102 generally comprises multiple blocks (or circuit) 110a-110n and multiple blocks (or circuits) 112a-112n. The circuit 106 generally comprises multiple blocks (or circuits) 114a-114n. The circuit 104 generally comprises a block (or circuit) 116 and a block (or circuit) 118. The circuits 110a to 118 may represent modules and/or blocks that may be implemented as hardware, software, a combination of hardware and software, or other implementations.

The signal AXC is shown implemented as multiple signals (e.g., AXCA-AXCN), a single signal for each of the N virtual channels. Each signal AXCA-AXCN is shown exchanged with a respective circuit 110a-110n. The signal I/O is shown exchanged with the circuit 118. Multiple pointer signals (e.g., VPTRA-VPTRN) are received by the respective circuits 110a-110n. Each signal VPTRA-VPTRN conveys a pointer to a current access location in the corresponding circuit 110a-110n. Multiple pointer signals (e.g., VBPTRA-VBPTRN) are received by the respective circuits 112a-112n. The signals VBPTRA-VBPTRN carry internal pointers to a current access location in the corresponding circuits 112a-112n. Multiple signals (e.g., WIDTHA-WIDTHN) are shown being received by the respective circuits 114a-114n. Each signal WIDTHA-WIDTHN carries some of the configuration information defining the widths of the samples in the corresponding channels. Multiple signals (e.g., SA-SN) are received by the respective circuits 114a-114n. Each signal SA-SN conveys some of the configuration information defining a number of samples in the corresponding channels. Multiple signals (e.g., PTR) are shown being transferred among the circuits 114a-114n. Each signal PTR carries main pointers from a current circuit 114a-114n to a next circuit 114a-114n. A pointer signal (e.g., SBPTR) is generated by the circuit 106 and received by the circuit 116. The signal SBPTR carries a current access location in the circuit 116. A pointer signal (e.g., SPTR) is generated by the circuit 106 and received by the circuit 118. The signal SPTR carries a current access location in the circuit 118.

Each circuit 110a-110n is shown implemented as a first-in-first-out buffer circuit. Each circuit 110a-110n has multiple sample slots that are accessed per the signals VPTRA-VPTRN. Each sample slot is sized to receive a widest sample used in the corresponding virtual channel. Each circuit 110a-110n generally operates on a single virtual channel. The number of circuits 110a-110n is expandable to accommodate more virtual channels. In the transmit mode, the circuits 110a-110n are operational to buffer the transmit samples received from the circuit 92 in the signals AXCA-AXCN, a single transit sample per sample slot. The circuits 110a-110n are also operational to present the transmit samples to the circuits 112a-112n, respectively, in the first-in-first-out sequence. In the receive mode, the circuits 110a-110n are operational to buffer the receive samples received from the circuits 112a-112n respectively, a single receive sample per sample slot. The circuits 110a-110n are also operational to present the receive samples to the circuit 92 in the first-in-first-out sequence via the signals AXCA-AXCN.

The circuits 112a-112n are shown implemented as channel buffer circuits. Each circuit 112a-112n has a narrow depth (e.g., 1 bit depth) and has a width that matches or exceeds a sample slot size in the circuits 110a-110n. Access for reading and writing to the circuits 112a-112n is determined by the corresponding signals VBPTRA-VBPTRN. Each circuit 112a-112n generally operates with a single virtual channel. The number of circuits 112a-112n is expandable to accommodate more virtual channels.

The circuits 114a-114n are shown implemented as a processor circuits (or elements). The circuits 114a-114n are operational to control transfers of the samples between the circuits 110a-110n, the circuits 112a-112n, the circuit 116 and the circuit 118 using the corresponding pointer signals. For example, the circuit 114a generates the signals VPTRA and VBPTRA to control the circuits 110a and 112a, respectively. The circuit 114a also shares control of the main pointer signals SBPTR and SPTR with the other circuits 114b-114n to read and write from the circuits 116 and 118. Control of the signals SBPTR and SPTR are transferred among the circuits 114a-114n through the signals PTR, with a single circuit 114a-114n in control at any given time.

Each circuit 114a-114n generally operates on a single virtual channel. The number of samples to transfer are provided to the circuits 114a-114n via the signals SA-SN. The width of the samples being transferred are provided to the circuits 114a-114n via the signals WIDTHA-WIDTHN. The number of circuits 114a-114n is expandable to accommodate more virtual channels. The programming (e.g., software, code, firmware, program instructions) of the circuits 114a-114n is also flexible to account for existing protocols and new protocols that may be developed at a later date.

The circuit 116 is shown implemented as a sample buffer circuit. The circuit 116 has a narrow depth (e.g., 1 bit depth) and has a width that matches or exceeds a frame slot size in the circuit 118. The circuit 116 is operational to buffer one or more frames, where each frame contains multiple samples from multiple virtual channels. Access to read and write from the circuit 116 is determine by the signal SBPTR.

The circuit 118 is shown implemented as an IQ mapped sample (or frame) buffer circuit. The circuit 118 is operational to buffer multiple frames in transit between the circuit 94 and the circuit 116. Each frame is stored in a respective frame slot. Access to read and write from the frame slots is determine by the signal SPTR.

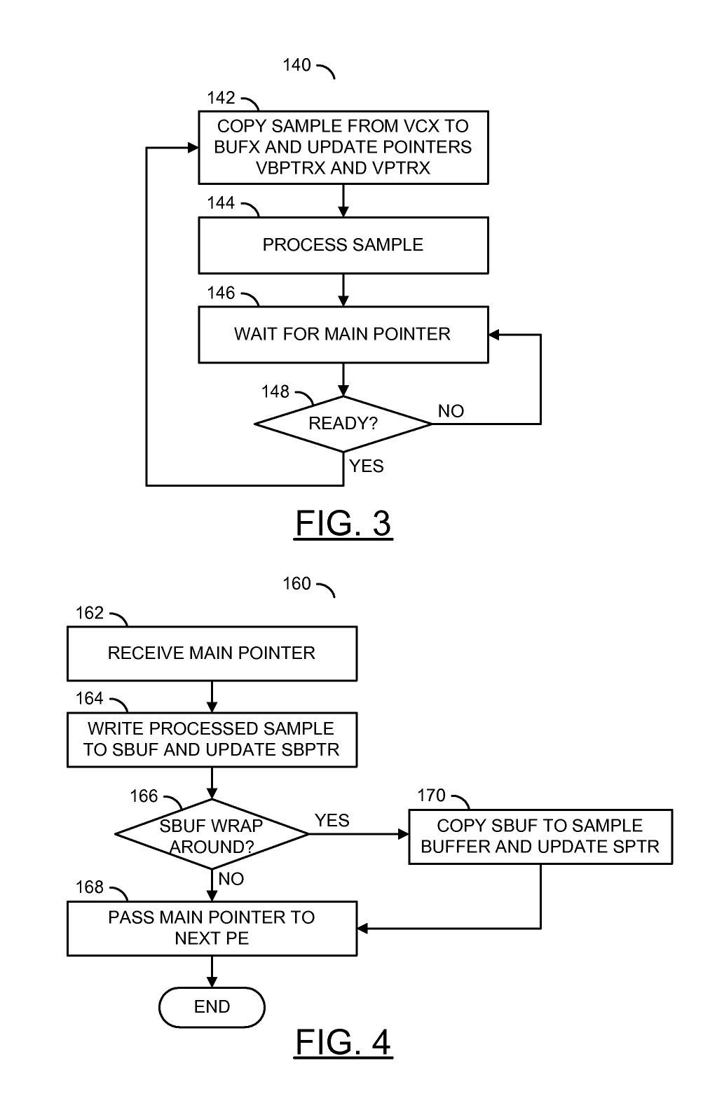

Referring to FIG. 3, a flow diagram of an example method 140 for gathering and processing transmit samples is shown. The method (or process) 140 is implemented by the circuit 100. The method 140 generally comprises a step (or state) 142, a step (or state) 144, a step (or state) 146 and a step (or state) 148. The steps 142-148 may represent modules and/or blocks that may be implemented as hardware, software, a combination of hardware and software, or other implementations.

The circuits 102, 104 and 106 accomplish variable width time division multiplexing of the IQ samples in the transmit mode. The IQ data samples are receive in the corresponding signals AXCA-AXCN. The samples are stored in the circuits 110a-110n corresponding to the respective virtual channels (e.g., VCA, VCB, . . . , VCN). In the step 142, the circuits 114a-114n read the corresponding circuits 110a-110n in a scheme (e.g., a round robin scheme) for the corresponding number of samples (e.g., SA, SB, . . . , SN) of corresponding width (e.g., WIDTHA, WIDTHB, . . . , WIDTHN). The reading is based on the pointer signals VPTRA-VPTRN. The signals VPTRA-VPTRN are subsequently updated by the number of samples just read to point to the next unread samples. The intermediate buffer circuits 112a-112n are used to assemble a unit of the samples read from the circuits 110a-110b. Each unit is usually Sx by WIDTHx bits long, were x=A, B, . . . , N. The pointer signals VBPTRA-VBPTRN are subsequently updated by the unit size (e.g., SA×WWIDTHA) to point to the next open space in the circuits 112a-112n. If the pointer values in the signals VBPTRA-VBPTRB wraps around the ends of the corresponding circuit 112a-112n, the samples stored in the circuits 112a-112n are transferred to the corresponding circuits 114a-114n. The pointer values in the signals VPTRA-VPTRN and VBPTRA-VBPTRN are stored locally in the respective circuits 114a-114n. The control transitions from a current circuit 114a-114n to a next circuit 114a-114n can also be devised in other than the round robin case. Passing of the main pointer can be controlled from a software layer so that the next circuit 114a-114n can be selected out of sequence.

The sample units are read and processed by the circuits 114a-114n in the step 144. In the step 146, each circuit 114a-114n waits for control of the signals SBPTR and SPTR to access to the circuit 104. If control is not available per the step 148, the circuits 114a-144n continue to wait. Once control is received per the step 148, the controlling circuit 114a-114n writes the processed samples to the circuit 116 (see FIG. 4) and returns to the step 142 to assemble the next sample unit.

Referring to FIG. 4, a flow diagram of an example method 160 for mapping the transmit samples into a frame is shown. The method (or process) 160 is implemented by the circuit 100. The method 160 generally comprises a step (or state) 162, a step (or state) 164, a step (or state) 166, a step (or state) 168 and a step (or state) 170. The steps 162-170 may represent modules and/or blocks that may be implemented as hardware, software, a combination of hardware and software, or other implementations.

In the step 162, the main pointer signal PTR passes control from the previous circuit 114a-114n to a current circuit 114a-114n. The current circuit 114a-114n subsequently writes the processed transmit data to the circuit 116 starting at the location identified by the signal SBPTR in the step 164. The signal SBPTR is updated by the sample unit size (e.g., SA×WIDTHA bits) to point to a next available space in the circuit 116. If the pointer value in the signal SBPTR does not warp around an end of the circuit 116 per the step 166, the current circuit 114a-114n passes control of the main pointer (e.g., SBPTR and SPTR) to the next circuit 114a-114n in the step 168. The next circuit 114a-114n subsequently begins the method 160 at the step 162. Once the pointer value in the signal SBPTR wraps around the end of the circuit 116 per the step 166, the current circuit 114a-114n copies the contents of the circuit 116 into a frame slot in the circuit 118 in the step 170. The current circuit 114a-114n also updates the pointer value in the signal SPTR to point to the next available frame slot in the circuit 118. Once the frame has been copied into the circuit 118 and the signal SPTR has been updated, the current circuit 114a-114n passes access control for the circuit 104 to the next circuit 114a-114n in the step 168. The process of transferring the main pointer continues until all of the circuits 114a-114n have had an opportunity to write processed transmit samples into the circuit 116. Control is subsequently restarted again with the circuit 114a to write the next set of processed transmit samples.

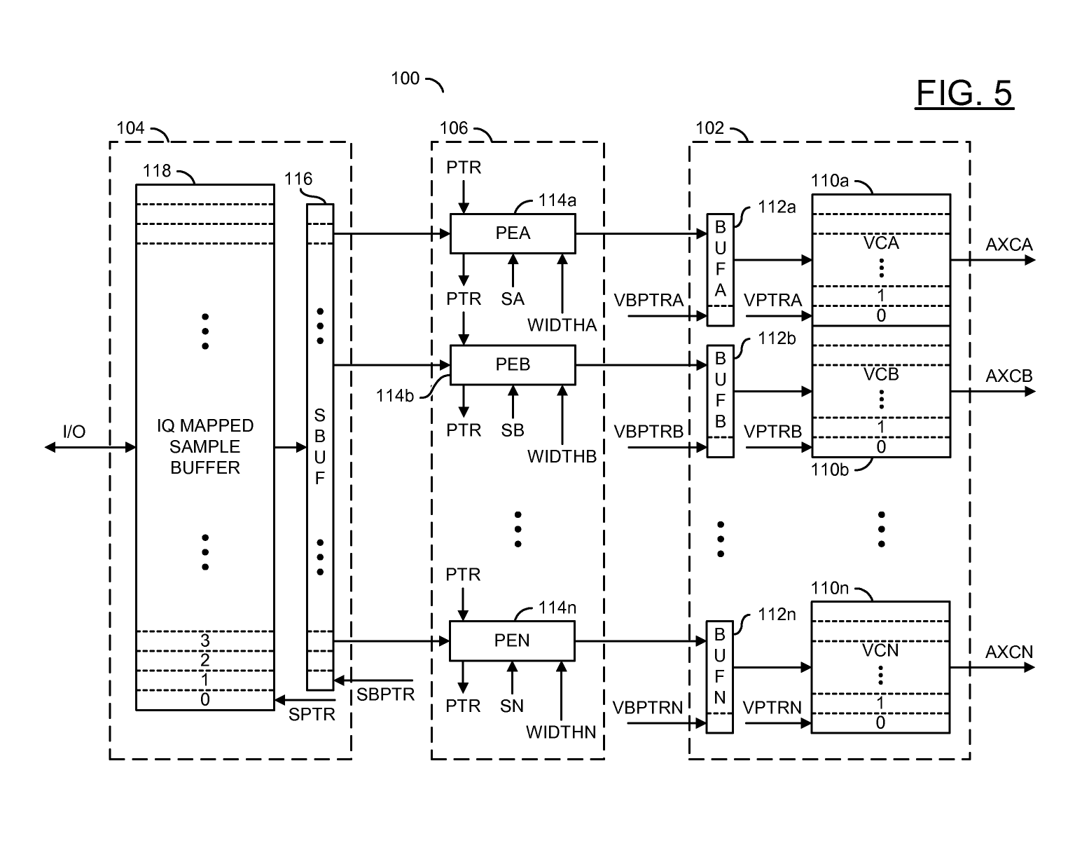

Referring to FIG. 5, a block diagram of an example implementation of the mapping circuit 100 in a receive mode is shown. Receive frames presented by the circuit 94 in the signal I/O are stored in the frame slots of the circuit 118 and a current frame in the circuit 116. The circuits 114a-114n for the read path read corresponding number of samples (e.g., SA, SB, . . . , SN) of corresponding width (e.g., WIDTHA, WIDTHB, . . . , WIDTHN) of the current frame stored in the circuit 116. The receive samples are processed and stored in to corresponding circuits 112a-112n. From the circuits 112a-112n, the receive samples are stored in the respective circuits 110a-110n of the virtual channels VCA-VCN thus accomplishing the variable width writes.

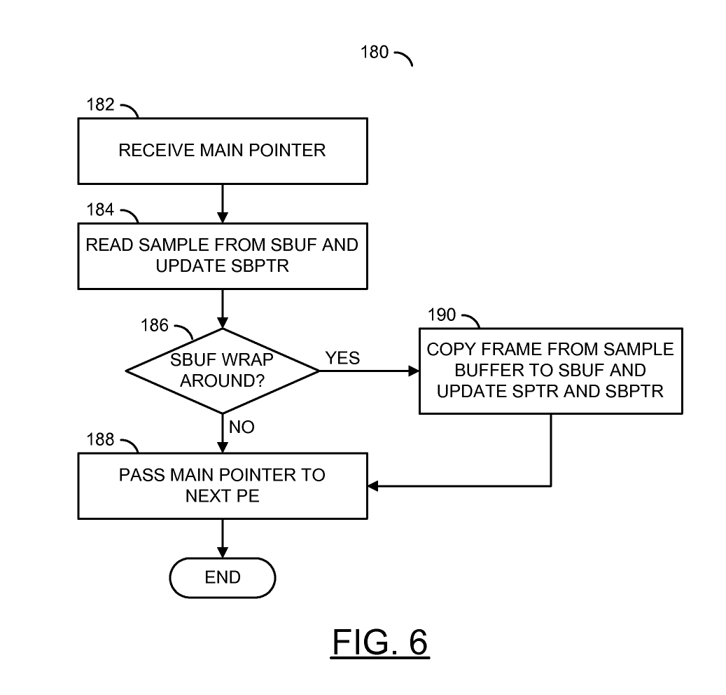

Referring to FIG. 6, a flow a flow diagram of an example method 180 for parsing the receive samples is shown. The method (or process) 180 is implemented by the circuit 100. The method 180 generally comprises a step (or state) 182, a step (or state) 184, a step (or state) 186, a step (or state) 188 and a step (or state) 190. The steps 182-190 may represent modules and/or blocks that may be implemented as hardware, software, a combination of hardware and software, or other implementations.

In the step 182, the main pointer signal PTR passes control from the previous circuit 114a-114n to a current circuit 114a-114n. The current circuit 114a-114n subsequently parses the received data from the circuit 116 by reading the samples starting at the location identified by the signal SBPTR in the step 184. The signal SBPTR is updated by the sample unit size (e.g., SA×WIDTHA bits) to point to a next sample unit in the circuit 116. If the pointer value in the signal SBPTR does not warp around an end of the circuit 116 per the step 186, the current circuit 114a-114n passes control of the main pointer (e.g., SBPTR and SPTR) to the next circuit 114a-114n in the step 188. The next circuit 114a-114n subsequently begins the method 180 at the step 182.

When the pointer value in the signal SBPTR wraps around the end of the circuit 116 per the step 186, the current circuit 114a-114n copies a next frame from the circuit 118 to the circuit 116 in the step 190. The frame is copied from the located identified by the signal SPTR. The current circuit 114a-114n also updates the pointer value in the signal SPTR to point to the next frame in the circuit 118. Once the frame has been copied into the circuit 116 and the signal SPTR has been updated, the current circuit 114a-114n passes access control for the circuit 104 to the next circuit 114a-114n in the step 188. The process of transferring the main pointer continues until all of the circuits 114a-114n have had an opportunity to read the receive samples from the circuit 116. Control is subsequently restarted again with the circuit 114a to read the next set of read samples.

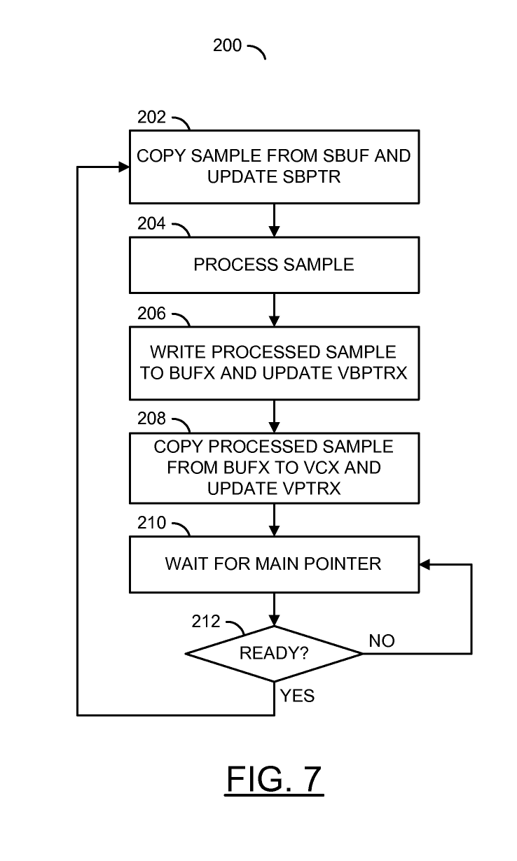

Referring to FIG. 7, a flow diagram of an example method 200 for processing and demapping the receive samples is shown. The method (or process) 200 is implemented by the circuit 100. The method 200 generally comprises a step (or state) 202, a step (or state) 204, a step (or state) 206, a step (or state) 208, a step or state) 210 and a step (or state) 212. The steps 202-212 may represent modules and/or blocks that may be implemented as hardware, software, a combination of hardware and software, or other implementations.

The circuits 102, 104 and 106 accomplish variable width time division demultiplexing of the receive samples in the receive mode. The IQ data samples are received by the circuit 100 in frames in the signal I/O from the circuit 94. The frames are stored in the circuit 118 and a current frame is copied from the circuit 118 to the circuit 116 under the control of a current circuit 114a-114n. The current circuit 114a-114n reads a corresponding number of samples (e.g., SA, SB, . . . , SN) of corresponding width (e.g., WIDTHA, WIDTHB, . . . , WIDTHN) from the circuit 116 in the step 202. The reading is based on the pointer value in the signal SBPTR. The signal SBPTR is subsequently updated by the number of samples just read times the sample width (e.g., SA×WIDTHA) to point to the next unread read sample in the circuit 116. Each unit read from the circuit 116 is usually Sx by WIDTHx bits long, were x=A, B, . . . , N.

The sample units read from the circuit 116 are processed by the circuits 114a-114n in the step 204. The processed read samples are written into the corresponding circuits 112a-112n in the step 206. The locations for the writes are identified by the pointer values in the signals VBPTRA-VBPTRN, respectively. The signals VBPTRA-VBPTRN are updated accordingly to point to the next open space in the circuits 112a-112n after the writes. Whenever a signal VBPTRA-VBPTRN wraps around an end of the corresponding circuit 112a-112n, the contents in the wrapped circuit 112a-112n is copied into an open sample slot of the associated circuit 110a-110n in the step 208. The pointer values in the signals VPTRA-VPTRN are also updated to point to the next available sample slot in the circuits 110a-110n. Each circuit 114a-114n stores values for the signals VBPTRA-VBPTRN and VPTRA-VPTRN locally. The demultiplexed receive samples are subsequently read by the circuit 92 via the corresponding signals AXCA-AXCN.

In the step 210, each circuit 114a-114n waits for control of the signals SBPTR and SPTR to access to the circuit 104. If control is not available per the step 212, the circuits 114a-144n continue to wait. Once control is received per the step 212, the controlling circuit 114a-114n reads a new received sample unit from the circuit 116 (see FIG. 6) in the step 202 and processes the new receive samples.

Operations in the circuit 100 provide for an exchange of the main pointer (e.g., the pointer values in the signals SBPTR and SPTR) among the circuits 114a-114n in a round robin manner to manage the mapping of the IQ samples. The circuits 114a-114n use the signals SBPTR and VBPTRA-VBPTRN to access the intermediate circuits 116 and 112a-112n, thus achieving variable width sample reads and writes between the circuit 118 and the circuits 110a-110n. A combination of the circuits 114a-114n (e.g., the processing elements), the buffers in the circuits 110a-110n and the buffer in the circuit 116 obtain a modular, repetitive and therefore scalable structure to perform the mapping/demapping. The scheme is suitable for intellectual property based designs due to the modular structure of the components within the circuits 102 and 106. The modular structure is usable in both a transmit path and a receive path reversing the processing element interface functionality between the circuits 102 and 104. No granular limitations exist on the width of the IQ samples to be mapped (multiplexed) or un-mapped (demultiplexed). In some embodiments, the circuits 112a-112n can have shadow registers in a pipeline to support advanced fetches of the IQ samples from the circuits 110a-110n to reduce access time by respective circuits 114a-114n in the transmit mode (or direction). Similarly, the circuit 116 can also have a shadow register for improving access time by circuits 114a-114n in the receive mode (or direction).

The functions performed by the diagrams of FIGS. 1-7 may be implemented using one or more of a conventional general purpose processor, digital computer, microprocessor, microcontroller, RISC (reduced instruction set computer) processor, CISC (complex instruction set computer) processor. SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (erasable programmable ROMs), EEPROMs (electrically erasable programmable ROMs), UVPROM (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a plurality of first circuits each configured to store a plurality of samples corresponding to a plurality of channels, at least two of said samples having different widths;
a second circuit configured to store a plurality of frames each sized to contain two or more of said samples; and
a plurality of processor circuits configured to (i) read said samples from said first circuits respectively, (ii) generate a transmit one of said frames by writing said samples to said second circuit based on one or more access pointers and (iii) pass control of said access pointers among said processor circuits.

2. The apparatus according to claim 1, wherein (i) said second circuit includes a frame buffer configured to store said frames and an intermediate buffer configured to store a current one of said frames, (ii) said access pointers include a first pointer configured to access said frame buffer and a second pointer configured to access said intermediate buffer and (iii) both said first pointer and said second pointer are passed among said processor circuits.

3. The apparatus according to claim 2, wherein said processor circuits are further configured to transfer said current frame from said intermediate buffer to said frame buffer in response to said second pointer wrapping around an end of said intermediate buffer.

4. The apparatus according to claim 1, wherein (i) each of said processor circuits is configured to generate one or more internal pointers configured to access said first circuits and (ii) said internal pointers are stored locally within said processor circuits.

5. The apparatus according to claim 4, wherein (i) each of said first circuits includes an intermediate buffer configured to store at least a widest one of said samples and a channel buffer configured to store two or more of said samples and (ii) each of said internal pointers includes a first pointer configured to access said intermediate buffer and a second pointer configured to access said channel buffer.

6. The apparatus according to claim 5, wherein each of said processor circuits is further configured to transfer one or more of said samples from said channel buffer to said intermediate buffer based on said first pointer and said second pointer.

7. The apparatus according to claim 1, wherein each of said frames is configured to be transmitted in a radio downlink.

8. The apparatus according to claim 1, wherein said processor circuits are further configured to (i) read a receive one of said frames from said second circuit based on said one or more access pointers and (ii) write said samples to said first circuits respectively.

9. The apparatus according to claim 1, wherein said apparatus is implemented as one or more integrated circuits.

10. An apparatus comprising:
a plurality of first circuits each configured to store a plurality of samples corresponding to a plurality of channels, at least two of said samples having different widths;
a second circuit configured to store one or more frames each sized to contain two or more of said samples; and
a plurality of processor circuits configured to (i) read a receive one of said frames from said second circuit based on one or more access pointers, (ii) write said samples to said first circuits respectively and (iii) pass control of said access pointers among said processor circuits.

11. The apparatus according to claim 10, wherein (i) said second circuit includes a frame buffer configured to store said frames and an intermediate buffer configured to store a current one of said frames, (ii) said access pointers include a first pointer configured to access said frame buffer and a second pointer configured to access said intermediate buffer and (iii) both said first pointer and said second pointer are passed among said processor circuits.

12. The apparatus according to claim 11, wherein said processor circuits are further configured to transfer said current frame from said frame buffer to said intermediate buffer in response to said second pointer wrapping around an end of said intermediate buffer.

13. The apparatus according to claim 10, wherein (i) each of said processor circuits is configured to generate one or more internal pointers configured to access said first circuits and (ii) said internal pointers are stored locally within said processor circuits.

14. The apparatus according to claim 13, wherein (i) each of said first circuits includes an intermediate buffer configured to store at least a widest one of said samples and a channel buffer configured to store two or more of said samples and (ii) each of said internal pointers includes a first pointer configured to access said intermediate buffer and a second pointer configured to access said channel buffer.

15. The apparatus according to claim 14, wherein each of said processor circuits is further configured to transfer one or more of said samples from said intermediate buffer to said channel buffer based on said first pointer and said second pointer.

16. The apparatus according to claim 10, wherein each of said frames is configured to be received in a radio uplink.

17. The apparatus according to claim 10, wherein said processor circuits are further configured to (i) read said samples from said first circuits respectively and (ii) generate a transmit one of said frames by writing said samples to said second circuit based on said one or more access pointers.

18. The apparatus according to claim 10, wherein said apparatus is implemented as one or more integrated circuits.
